(19) United States
(12) Patent Application Publication
(10) Pub. No.: US 2022/0164908 A1
(43) Pub. Date: May 26, 2022

(54) Method And System For Earthquake Disaster Level Assessment

(71) Applicant: Ocean University of China, Qingdao (CN)

(72) Inventors: Peishun Liu, Qingdao (CN); Xinli Qiu, Qingdao (CN); Ruichun Tang, Qingdao (CN); Jing Zhang, Qingdao (CN)

(21) Appl. No.: 17/398,525

(22) Filed: Aug. 10, 2021

(30) Foreign Application Priority Data
Nov. 25, 2020 (CN) 202011341065.4

(51) Int. Cl. G06Q 50/26; G06Q 10/06

(52) U.S. Cl. CPC G06Q 50/26; G06Q 10/0635

(57) ABSTRACT

The present disclosure provides a method and system for earthquake disaster level assessment. The method includes: obtaining earthquake disaster information at an initial stage of an earthquake; determining a casualty assessment model based on an epicentral intensity as a core factor, an earthquake magnitude, a seismic intensity, an earthquake origin time, and a population density in a seismic area; determining an earthquake economic loss assessment model based on the earthquake magnitude, the seismic intensity, and gross domestic product (GDP) per capita; establishing an earthquake disaster level assessment model based on the casualty assessment model and the earthquake economic loss assessment model; and determining an earthquake disaster level based on the earthquake disaster level assessment model and initiating an emergency response based on the earthquake disaster level. The present disclosure can quickly assess an earthquake disaster level and initiate an emergency response.

### CROSS REFERENCE TO RELATED APPLICATION(S)

This patent application claims the benefit and priority of Chinese Patent Application No. 202011341065.4 filed on Nov. 25, 2020, the disclosure of which is incorporated by reference herein in its entirety as part of the present application.

### TECHNICAL FIELD

The present disclosure relates to the field of earthquake disaster level assessment, and in particular, to a method and system for an earthquake disaster level assessment.

### BACKGROUND ART

An earthquake is a devastating natural disaster. A strong earthquake causes severe human and animal casualties and a significant property loss. Reporting of disaster information about a disaster area after a strong earthquake is limited by factors such as an environment of the disaster area and failures of electric power communication. As a result, the disaster information cannot he accurately obtained in time. How to quickly determine a severity, a level, spatial distribution, and a casualty toll in a disaster area after an earthquake is an important issue that affects earthquake emergency rescues.

A method for a level classification of earthquake disaster areas is proposed in the “Guidelines for Earthquake Disaster Area Level Assessment”. This method uses a comprehensive disaster index as an indicator and county-level divisions as a statistical unit to determine earthquake disaster areas, classify levels of the disaster areas, and rank the disaster areas by disaster severity. This method provides a scientific basis for governments to quickly carry out earthquake relief and recovery and reconstruction, and pave the way for emergency rescue and recovery and reconstruction work. A calculation method of the comprehensive disaster index is complicated, and requires detailed statistics on a death toll and a number of missing persons, sampling of house damage, assessment of economic losses, and statistics on occurrence of geological disasters after an earthquake. Therefore, the levels of the disaster areas cannot be effectively assessed in time.

When an earthquake occurs, a disaster level needs to he determined based on loss degrees in all aspects to initiate a corresponding emergency plan. An existing earthquake disaster level assessment method mainly involves reference factors such as a casualty toll, a house damage degree, an economic loss, an earthquake magnitude, and a seismic intensity. Many reference factors can only be obtained through detailed investigation after the earthquake, and cannot provide timely reference for emergency responses.

### SUMMARY

The present disclosure provides an earthquake disaster level assessment method and system to quickly assess an earthquake disaster level and initiate an emergency response at an initial stage of an earthquake.

To implement the foregoing objectives, the present disclosure provides the following solutions.

A method for earthquake disaster level assessment includes:

obtaining earthquake disaster information at an initial stage of an earthquake, where the earthquake disaster information includes an earthquake magnitude, an epicentral intensity, a seismic intensity, an earthquake origin time, gross domestic product (GDP) per capita in an epicentral area, and a population density in a seismic area;

determining a casualty assessment model based on the epicentral intensity as a core factor, the earthquake magnitude, the seismic intensity, the earthquake origin time, and the population density in the seismic area;

determining an earthquake economic loss assessment model based on the earthquake magnitude, the seismic intensity, and the GDP per capita;

establishing an earthquake disaster level assessment model based on the casualty assessment model and the earthquake economic loss assessment model; and

determining an earthquake disaster level based on the earthquake disaster level assessment model and initiating an emergency response based on the earthquake disaster level.

Optionally, the determining a casualty assessment model based on the epicentral intensity as a core factor, the earthquake magnitude, the seismic intensity, the earthquake origin time, and the population density in the seismic area may specifically include:

determining the casualty assessment model based on the following formula:

$$D = {α}_{m} \cdot {f}_{den} \cdot {f}_{t} \cdot {D}_{m} = {α}_{m} \cdot {f}_{den} \cdot {f}_{t} \cdot {e}^{12.2 {e}^{- {( ln ( I ) - 2.445 )}^{2} / {0.3}^{2}}} ,$$

where D is an assessed earthquake death toll; αₘ is an earthquake magnitude correction factor; fₜ is an earthquake origin time correction factor; f_{den} is a population density correction factor; Dₘ is an average earthquake death toll obtained through fitting based on the epicentral intensity; and I is the epicentral intensity.

Optionally, the determining an earthquake economic loss assessment model based on the earthquake magnitude, the seismic intensity, and the GDP per capita may specifically include:

determining the earthquake economic loss assessment model based on the following formula:

$$L = {γα}_{m} {L}_{m} = γ \cdot \frac{m + 0.669}{0.533 I + 2.669} \cdot {10}^{0.5996 m + 0.4011} ,$$

where L represents an assessed earthquake economic loss; Lₘ represents an earthquake economic loss obtained through fitting based on the earthquake magnitude; m represents the earthquake magnitude; and γ represents a correction factor for an economic development level in the seismic area.

Optionally, the establishing an earthquake disaster level assessment model based on the casualty assessment model and the earthquake economic loss assessment model may specifically include:

establishing the earthquake disaster level assessment model based on the following formula: σ=L+[a(f(R)−L)+b(f(G)−L)], where σ represents the earthquake disaster level; a represents a weighting factor of a relative value of a casualty toll to the earthquake disaster level, b represents a weighting factor of a relative value of the economic loss to the earthquake disaster level, and a+b=1; f(R) represents an earthquake disaster level corresponding to the casualty toll; and f(G) represents an earthquake disaster level corresponding to the relative value of the economic loss,

A system for earthquake disaster level assessment includes:

an earthquake disaster information obtaining module, configured to obtain earthquake disaster information at an initial stage of an earthquake, where the earthquake disaster information includes an earthquake magnitude, an epicentral intensity, a seismic intensity, an earthquake origin time, GDP per capita in an epicentral area, and a population density in a seismic area:

a casualty assessment model determining module, configured to determine a casualty assessment model based on the epicentral intensity as a core factor, the earthquake magnitude, the seismic intensity, the earthquake origin time, and the population density in the seismic area;

an earthquake economic loss assessment model determining module, configured to determine an earthquake economic loss assessment model based on the earthquake magnitude, the seismic intensity, and the GDP per capita;

an earthquake disaster level assessment model establishing module, configured to establish an earthquake disaster level assessment model based on the casualty assessment model and the earthquake economic loss assessment model; and

an earthquake disaster level determining module, configured to determine an earthquake disaster level based on the earthquake disaster level assessment model and initiate an emergency response based on the earthquake disaster level.

Optionally, the casualty assessment model determining module may specifically include:

a casualty assessment model determining unit, configured to determine the casualty assessment model based on the following formula:

$$D = {α}_{m} \cdot {f}_{den} \cdot {f}_{t} \cdot {D}_{m} = {α}_{m} \cdot {f}_{den} \cdot {f}_{t} \cdot {e}^{12.2 {e}^{- {( ln ( I ) - 2.445 )}^{2} / {0.3}^{2}}} ,$$

where D is an assessed earthquake death toll; αₘ is an earthquake magnitude correction factor; fₜ is an earthquake origin time correction factor; f_{den} is a population density correction factor; Dₘ is an average earthquake death toll obtained through fitting based on the epicentral intensity; and I is the epicentral intensity.

Optionally, the earthquake economic loss assessment model determining module may specifically include:

an earthquake economic loss assessment model determining unit, configured to determine the earthquake economic loss assessment model based on the following formula:

$$L = {γα}_{m} {L}_{m} = γ \cdot \frac{m + 0.669}{0.533 I + 2.669} \cdot {10}^{0.5996 m + 0.4011} ,$$

where L represents an assessed earthquake economic loss; Lₘ represents an earthquake economic loss obtained through fitting based on the earthquake magnitude; m represents the earthquake magnitude; and γ represents a correction factor for an economic development level in the seismic area.

Optionally, the earthquake disaster level assessment model establishing module may specifically include:

an earthquake disaster level assessment model establishing unit, configured to establish the earthquake disaster level assessment model based on the following formula: σ=L+[a(f(R)−L)+b(f(G)−L)], where σ represents the earthquake disaster level; a represents a weighting factor of a relative value of a casualty toll to the earthquake disaster level, b represents a weighting factor of a relative value of the economic loss to the earthquake disaster level, and a+b=1; f(R) represents an earthquake disaster level corresponding to the casualty toll; and f(G) represents an earthquake disaster level corresponding to the relative value of the economic loss.

According to the specific embodiments provided in the present disclosure, the present disclosure achieves the following technical effects. A method and system for an earthquake disaster level assessment are proposed. The following three factors are considered: an earthquake magnitude, a casualty toll, and an economic loss. Information about these factors can be obtained based on assessment models or from local statistical information in time at an initial stage of an earthquake. Therefore, an earthquake disaster level can be quickly assessed at the initial stage of the earthquake, and a corresponding emergency response can be quickly initiated, to provide a basis for initiation of an emergency response and make convenience for disaster relief work.

### BRIEF DESCRIPTION OF THE DRAWINGS

In order to explain the technical solutions in embodiments of the present disclosure or in the prior art more clearly, the accompanying drawings required in the embodiments will be described below briefly. Apparently, the accompanying drawings in the following description show merely sonic embodiments of the present disclosure, and other drawings can be derived from these accompanying drawings by those of ordinary skill in the art without creative efforts.

FIG. 1 is a flowchart of a method for earthquake disaster level assessment according to the present disclosure; and

FIG. 2 is a structural diagram of a system for earthquake disaster level assessment according to the present disclosure.

### DETAILED DESCRIPTION OF THE EMBODIMENTS

The technical solutions of the embodiments of the present disclosure are clearly and completely described below with reference to the accompanying drawings. Apparently, the described embodiments are merely a part but not all of the embodiments of the present disclosure. All other embodiments obtained by a person of ordinary skill in the art based on the embodiments of the present disclosure without creative efforts shall fall within the protection scope of the present disclosure.

The present disclosure is intended to provide a method and system for earthquake disaster level assessment to quickly assess an earthquake disaster level at an initial stage of an earthquake based on various influencing factors such as an earthquake magnitude, an economic loss, and a number of disaster victims, thereby providing a basis for initiation of an emergency response and facilitating disaster relief work.

To make the foregoing objects, features, and advantages of the present disclosure clearer and more comprehensible, the present disclosure will be further described in detail below with reference to the accompanying drawings and specific embodiments.

Reporting of disaster information in a disaster area after a strong earthquake is limited by factors such as an environment of the disaster area, disaster severity, and communication in the disaster area. An earthquake magnitude can be directly obtained from a seismic network, and an epicentral intensity can be calculated by using a model. However, a death toll and an economic loss cannot be obtained in time and accurately. Therefore, after a destructive earthquake occurs, a number of earthquake victims and an economic loss need to be assessed by using specific earthquake assessment models to determine an earthquake disaster level, to provide an important basis for emergency decision-making. This is of great significance to protection against and mitigation of the earthquake.

However, assessment of the economic loss and the number of earthquake victims is full of challenges. There are many relevant factors, such as an earthquake magnitude, a seismic intensity, topographic and geological conditions, earthquake resistance of buildings, an economic development level in a disaster area, a population density, a consumption level, and an earthquake origin time. Difficulty in collecting statistics on specific influencing factors makes the scientific assessment thereof even harder. Therefore, it is necessary to select main influencing factors of the earthquake and continuously refine the assessment models to improve assessment accuracy.

In view of the foregoing problems, an earthquake disaster level assessment model is established through regression analysis of a large amount of earthquake disaster data and based on existing assessment models to make assessment results more accurate and proper.

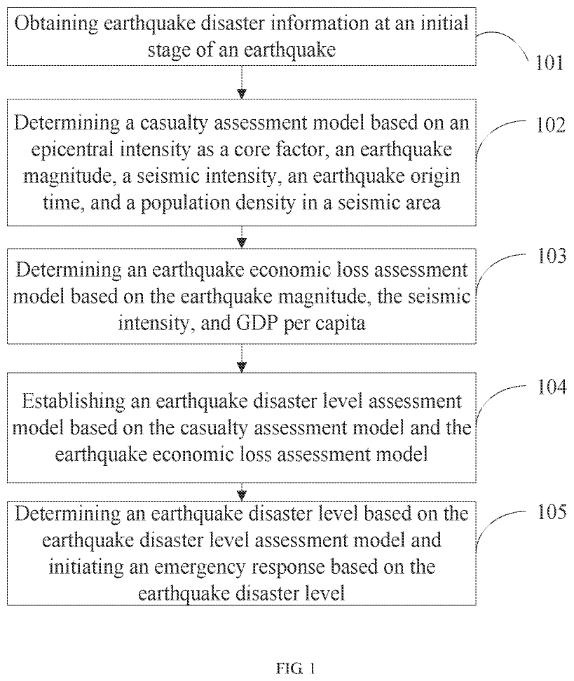

FIG. 1 is a flowchart of a method for earthquake disaster level assessment according to the present disclosure. The method includes the following steps.

In step 101, earthquake disaster information at an initial stage of an earthquake is obtained, where the earthquake disaster information includes an earthquake magnitude, an epicentral intensity, a seismic intensity, an earthquake origin time, GDP per capita in an epicentral area, and a population density in a seismic area.

After the earthquake occurs, relevant parameters such as the earthquake magnitude and geographic coordinates of an epicenter issued by the China Earthquake Administration (CEA) are used in conjunction with a joint seismic intensity attenuation model to quickly assess seismic intensity distribution with directionality. The joint seismic intensity attenuation model proposed by Wang Suyun can be used:

I=b₁+b₂m+b₃ln(Rₐ+b₄)+b₅ln(R_{b}+b₆)+ε (1)

where I is the seismic intensity; m is the earthquake magnitude; Rₐ and R_{b} are lengths of semi-major and semi-minor axes of an equal intensity respectively, and the unit of the lengths is km; b₁, b₂, b₃, b₄, b₅, and b₆ are regression constants; and ε is a random variable that represents uncertainty in regression analysis, and it is generally assumed that ε is subject to lognormal distribution with mean of zero. Table 1 is a schematic table of joint attenuation models in different regions of mainland China. For parameter values, refer to empirical formulas given in Table 1.

TABLE 1

| | | Standard |
|---|---|---|
| Region | Joint attenuation equation | deviation |
| Eastern China | Iₐ = 5.019 + 1.446m − 4.1361g(Rₐ + 24) | 0.517 |
| (east of 105° E) | I_{b} = 2.240 + 1.446m − 3.0701g(R_{b} + 9) | |
| Western China | Iₐ = 5.253 + 1.398m − 4.1641g(Rₐ + 26) | 0.632 |
| (west of 105° E) | I_{b} = 2.019 + 1.398m − 2.9431g(R_{b} + 8) | |
| Shanghai and its adjacent areas | Iₐ = 3.575 + 1.2972m − 3.09881g(Rₐ + 15) | 0.36 |
| (Shanghai, Jiangsu, Zhejiang, | I_{b} = 2.2339 + 1.2972m − 2.72541g(R_{b} + 7) | |
| Anhui, Fujian, and South Yellow | | |
| Sea) | | |
| Greater North China (Shandong, | Iₐ = 3.727 + 1.429m − 1.5381g(Rₐ + 12) | 0.518 |
| Shanxi, Shaanxi, Inner Mongolia, | I_{b} = 1.483 + 1.429m − 1.1381g(R_{b} + 4) | |
| Hebei, and Liaoning) | | |
| Southwest China (north of the | Iₐ = 7.3568 + 1.2780m − 5.06551g(Rₐ + 24) | 0.70 |
| Longmenshan fault zone, Anning | I_{b} = 3.9502 + 1.2780m − 3.75671g(R_{b} + 9) | |
| River, Zemu River, west of the | | |
| Xiaojiang fault zone, Sichuan, | | |
| Yunnan, and Gansu) | | |
| Sichuan Basin (south of the | Iₐ = 4.0293 + 1.3003m − 3.64041g(Rₐ + 10) | 0.45 |
| Longmenshan fault zone, Anning | I_{b} = 2.3816 + 1.3003m − 2.85731g(R_{b} + 5) | |
| River, Zemu River, east of the | | |
| Xiaojiang fault zone, Sichuan, | | |
| Chongqing, and Guizhou) | | |
| Central China and South China | Iₐ = 6.6079 + 0.9543m − 3.56881g(Rₐ + 18) | 0.540 |
| (Guangdong, Guangxi, Fujian, | I_{b} = 4.9540 + 0.9543m − 2.95661g(R_{b} + 9) | |
| Jiangxi, Henan, and Chongqing) | | |

Iₐ and I_{b} are seismic intensities on semi-major and semi-minor axes respectively; and Rₐ and R_{b} are lengths of semi-major and semi-minor axes of an elliptic isoseismal with an intensity of I respectively.

In step 102, a casualty assessment model is determined based on the epicentral intensity as a core factor, the earthquake magnitude, the seismic intensity, the earthquake origin time, and the population density in the seismic area.

The casualty assessment model is determined for earthquakes in China in recent years based on the epicentral intensity as the core factor and influencing factors such as the earthquake magnitude, the population density in the seismic area, and the earthquake origin time:

$$D = {α}_{m} \cdot {f}_{den} \cdot {f}_{t} \cdot {D}_{m} = {α}_{m} \cdot {f}_{den} \cdot {f}_{t} \cdot {e}^{12.2 {e}^{- {( ln ( I ) - 2.445 )}^{2} / {0.3}^{2}}} \qquad ( 2 )$$

where D is an assessed earthquake death toll; αₘ is an earthquake magnitude correction factor, which can be calculated by using formula 3; fₜ is an earthquake origin time correction factor, t is the earthquake origin time, and a value of this factor is determined based on Table 2; f_{den} is a population density correction factor, which can be calculated by using formula 4, and den is the population density; Dₘ is an average earthquake death toll obtained through fitting based on the epicentral intensity; and I is the epicentral intensity.

Calculating the earthquake magnitude correction factor:

When the epicentral intensity is the same, different earthquake magnitudes may lead to different proportions of intensity areas, and have a great influence on an earthquake casualty toll. The following earthquake magnitude correction factor is introduced:

$${α}_{m} = \frac{ln ( D )}{ln ( {D}_{m} )} = \frac{Mag - 5}{{Mag}_{m} - 5} \qquad ( 3 )$$

where αₘ is the earthquake magnitude correction factor, Mag is the actual earthquake magnitude, and Magₘ is an average earthquake magnitude corresponding to the epicentral intensity. Table 2 shows illustrative correspondences of epicentral intensities and average earthquake magnitudes.

TABLE 2
Correspondences of epicentral intensities and average earthquake magnitudes

| | Epicentral intensity | | | | |
|---|---|---|---|---|---|
| | VI | VII | VIII | IX | X |
| Average earthquake | 5.198 | 5.731 | 6.264 | 6.797 | 7.33 |
| magnitude (Magₘ) | | | | | |

The earthquake magnitude correction factor αₘ has the following physical meaning: when the epicentral intensity is the same and if the actual earthquake magnitude is greater than the average earthquake magnitude corresponding to the epicentral intensity, a proportion of the epicentral intensity is high, and the factor αₘ>1 needs to be multiplied. If the actual earthquake magnitude is less than the average earthquake magnitude corresponding to the epicentral intensity, the factor αₘ<1 needs to be multiplied. When αₘ<0, it is assumed that αₘ=1.

Calculating the population density correction factor:

The population density is also a key factor that affects the earthquake casualty toll. When the earthquake casualty assessment model is designed, the impact of the population density needs to be taken into account. The population density correction factor is calculated for China in 2019 through regression analysis and based on census data in 2018:

f_{den}=0.00707Den+0.0471 (4)

If the population density in the seismic area is known, the population density correction factor can be obtained. Then, the casualty assessment model can be corrected, so that an assessment result is more proper and accurate, and is close to an actual result.

Calculating the earthquake origin time correction factor:

When the epicentral intensity is the same, a death toll in a nighttime earthquake is greater than that in a daytime earthquake. Assume that a value of a correction factor for the daytime earthquake is 1. Table 3 shows illustrative earthquake origin time correction factors. Correction factors for the nighttime earthquake can he shown in Table 3.

TABLE 3

| | Epicentral intensity | | | |
|---|---|---|---|---|
| | VII | VIII | IX | X |
| Time correction factor | 1.8 | 1.4 | 1.2 | 1.1 |

In step 103, an earthquake economic loss assessment model is determined based on the earthquake magnitude, the seismic intensity, and the GDP per capita.

An economic loss can be assessed based on the earthquake magnitude, the seismic intensity, and the GDP per capita in the seismic area.

The earthquake economic loss assessment model is determined based on the following formula:

$$L = {γα}_{m} {L}_{m} = γ \cdot \frac{m + 0.669}{0.533 I + 2.669} \cdot {10}^{0.5996 m + 0.4011} \qquad ( 5 )$$

where L is an assessed earthquake economic loss; Lₘ is an earthquake economic loss obtained through fitting based on the earthquake magnitude; I is the epicentral intensity; m is the earthquake magnitude; and γ is a correction factor for an economic development level in the seismic area, and a value of γ is determined based on Table 3.

The correction factor for the economic development level in the seismic area:

The value of the correction factor γ for the economic development level is determined based on a specification related to earthquake disaster losses: Earthquake Field Work Part 4: Assessment of Direct Economic Losses. GDP per capita below 15,000 yuan represents an average economic development level, and the value of γ is 1.0; GDP per capita from 15,000 yuan to 30,000 yuan represents that the economic development level is relatively developed, and the value of γ is 1.15; and GDP per capita above 30,000 yuan represents that the economic development level is developed, and the value of γ is 1.3. Table 4 is a table of correction factors for the economic development level.

TABLE 4

| | Economic development level | | |
|---|---|---|---|
| | | Relatively | |
| | Developed | developed | Average |
| Correction factor γ | 1.3 | 1.15 | 1.0 |

In step 104, an earthquake disaster level assessment model is established based on the casualty assessment model and the earthquake economic loss assessment model.

The earthquake disaster level is determined by factors such as the earthquake magnitude, the casualty toll, and the economic loss. The earthquake disaster level assessment model is determined based on the following formula:

σ=L+[a(f(R)−L)+b(f(G)−L)] (6)

where σ represents an assessed earthquake disaster level; and a represents a weighting factor of a relative casualty toll to the earthquake disaster level, b represents a weighting factor of a relative economic loss to the earthquake disaster level, and a+b =1 Generally, weights of the casualty toll and the economic loss are both 0.5. f(R) represents an earthquake disaster level corresponding to the casualty toll, and is calculated by using formula 7; and f(G) represents an earthquake disaster level corresponding to the relative economic loss, and is calculated by using formula 8. An emergency response level assessment method is formulated based on the assessed earthquake disaster level. If the assessed level is above 6.5, a first-level response is initiated for a general disaster area, a relatively severely affected area, a severely affected area, and an extremely severely affected area, If the assessed level is between 5.5 and 6.5, a second-level response is initiated for the general disaster area, relatively severely affected area, and severely affected area. If the assessed level is between 4.5 and 5.5, a three-level response is initiated for the general disaster area and relatively severely affected area. If the assessed level is below 4.5, a four-level response is initiated for the general disaster area.

$$f ( R ) = \frac{ln ( R \times {10}^{5} )}{1.5643} , R = \frac{D}{P} \approx 1 E - 0.5 {e}^{1.5463 M} \qquad ( 7 )$$

where D represents the assessed casualty toll, P represents a total population in the disaster area, M represents the earthquake magnitude, and R represents a ratio of the assessed death toll to the population in the disaster area and can be quickly estimated by using 1E−0.5e^{1.564M}. A maximum earthquake magnitude is 9. If a calculation result exceeds 9, it is considered that the earthquake magnitude is 9.

f(G) represents an earthquake magnitude inferred based on historical data and experience in previous years when a maximum direct economic loss is Eₘₐₓ, the number of earthquake victims is P₁, the GDP per capita in the disaster area is g, and a ratio is G. A maximum value of f(G) is 9. If a calculation result exceeds 9, it is considered that the earthquake magnitude is 9. The following formula is used:

$$f ( G ) = \frac{ln ( G \times {10}^{4} )}{1.2193} = \frac{ln ( \frac{{E}_{max}}{g \times {P}_{1}} \times {10}^{4} )}{1.2193} \qquad ( 8 )$$

where g represents the GDP per capita in the disaster area, and G represents a relative value of the direct economic loss, namely, a ratio of the direct economic loss to a product of the number of earthquake victims and the GDP per capita in the disaster area.

In step 105, the earthquake disaster level is determined based on the earthquake disaster level assessment model, and an emergency response is initiated based on the earthquake disaster level.

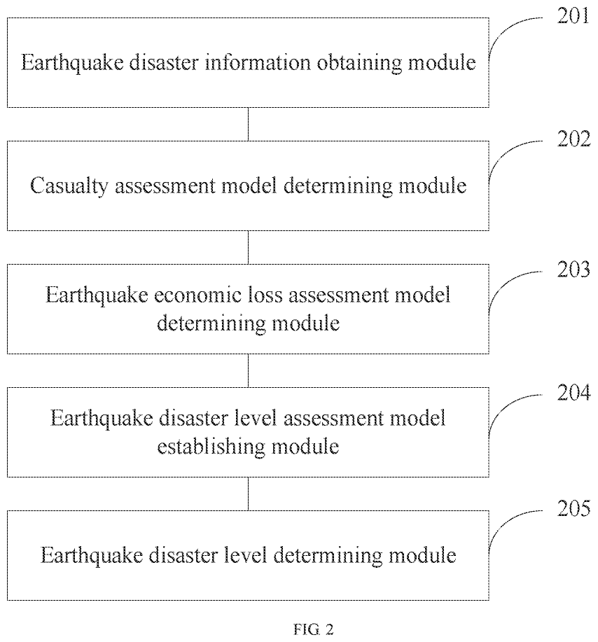

FIG. 2 is a structural diagram of an earthquake disaster level assessment system according to the present disclosure. As shown in the FIG. 2, the system includes the following modules:

An earthquake disaster information obtaining module 201 is configured to obtain earthquake disaster information at an initial stage of an earthquake, where the earthquake disaster information includes an earthquake magnitude, an epicentral intensity, a seismic intensity, an earthquake origin time, GDP per capita in an epicentral area, and a population density in a seismic area.

A casualty assessment model determining module 202 is configured to determine a casualty assessment model based on the epicentral intensity as a core factor, the earthquake magnitude, the seismic intensity, the earthquake origin time, and the population density in the seismic area.

The casualty assessment model determining module 202 may specifically include a casualty assessment model determining unit, configured to determine the casualty assessment model based on the following formula:

$$D = {α}_{m} \cdot {f}_{den} \cdot {f}_{t} \cdot {D}_{m} = {α}_{m} \cdot {f}_{den} \cdot {f}_{t} \cdot {e}^{12.2 {e}^{- {( ln ( I ) - 2.445 )}^{2} / {0.3}^{2}}} ,$$

where D is an assessed earthquake death toll; αₘ is an earthquake magnitude correction factor; f^{t} is an earthquake origin time correction factor; f_{den} is a population density correction factor; Dₘ is an average earthquake death toll obtained through fitting based on the epicentral intensity; and I is the epicentral intensity.

An earthquake economic loss assessment model determining module 203 is configured to determine an earthquake economic loss assessment model based on the earthquake magnitude, the seismic intensity, and the GDP per capita.

The earthquake economic loss assessment model determining module 203 may specifically include an earthquake economic loss assessment model determining unit, configured to determine the earthquake economic loss assessment model based on the following formula:

$$L = {γα}_{m} {L}_{m} = γ \cdot \frac{m + 0.669}{0.533 I + 2.669} \cdot {10}^{0.5996 m + 0.4011} ,$$

where L represents an assessed earthquake economic loss; Lₘ represents an earthquake economic loss obtained through fitting based on the earthquake magnitude; m represents the earthquake magnitude; and γ represents a correction factor for an economic development level in the seismic area.

An earthquake disaster level assessment model establishing module 204 is configured to establish an earthquake disaster level assessment model based on the casualty assessment model and the earthquake economic loss assessment model.

The earthquake disaster level assessment model establishing module 204 may specifically include an earthquake disaster level assessment model establishing unit, configured to establish the earthquake disaster level assessment model based on the following formula: π=L+[a(f(R)−L)+b(f(G)−L)], where σ represents an assessed earthquake disaster level; a represents a weighting factor of a relative value of a casualty toll to the earthquake disaster level, b represents a weighting factor of a relative value of the economic loss to the earthquake disaster level, and a+b=1; f(R) represents an earthquake disaster level corresponding to the casualty toll; and f(G) represents an earthquake disaster level corresponding to the relative value of the economic loss.

An earthquake disaster level determining module 205 is configured to determine the earthquake disaster level based on the earthquake disaster level assessment model and initiate an emergency response based on the earthquake disaster level.

The present disclosure quickly assesses an earthquake disaster level after an earthquake occurs by using an earthquake disaster level assessment model and based on disaster information such as an earthquake magnitude, an earthquake origin time, and a seismic intensity at an initial stage of the earthquake, and general information such as an average population density and GDP per capita in a disaster area, to provide a scientific basis for emergency relief of the earthquake.

Each embodiment of this specification is described in a progressive manner, each embodiment focuses on the difference from other embodiments, and the same and similar parts between the embodiments may refer to each other. For the system disclosed in the embodiments, since the system corresponds to the method disclosed in the embodiments, the description is relatively simple, and reference can be made to the method description.

In this specification, several specific embodiments are used for illustration of the principles and implementations of the present disclosure. The description of the foregoing embodiments is used to help illustrate the method of the present disclosure and the core ideas thereof. In addition, persons of ordinary skill in the art can make various modifications in terms of specific implementations and the scope of application in accordance with the ideas of the present disclosure. In conclusion, the content of this specification shall not he construed as a limitation to the present disclosure.

What is claimed is:

1. A method for earthquake disaster level assessment, comprising:
obtaining earthquake disaster information at an initial stage of an earthquake, wherein the earthquake disaster information comprises an earthquake magnitude, an epicentral intensity, a seismic intensity, an earthquake origin time, gross domestic product (GDP) per capita in an epicentral area, and a population density in a seismic area;
determining a casualty assessment model based on the epicentral intensity a core factor, the earthquake magnitude, the seismic intensity, the earthquake origin time, and the population density in the seismic area;
determining an earthquake economic loss assessment model based on the earthquake magnitude, the seismic intensity, and the GDP per capita;
establishing an earthquake disaster level assessment model based on the casualty assessment model and the earthquake economic loss assessment model; and
determining an earthquake disaster level based on the earthquake disaster level assessment model and initiating an emergency response based on the earthquake disaster level,
wherein if the determined earthquake disaster level is above 6.5, a first-level response is initiated for a general disaster area, a relatively severely affected area, a severely affected area, and an extremely severely affected area; if the determined earthquake disaster level is between 5.5 and 6.5, a second-level response is initiated for the general disaster area, relatively severely affected area, and severely affected area; if the determined earthquake disaster level is between 4.5 and 5.5, a three-level response is initiated for the general disaster area and relatively severely affected area; if the determined earthquake disaster level is below 4.5, a four-level response is initiated for the general disaster area.

2. The method for earthquake disaster level assessment according to claim 1, wherein the determining a casualty assessment model based on the epicentral intensity as a core factor, the earthquake magnitude, the seismic intensity, the earthquake origin time, and the population density in the seismic area specifically comprises:
determining the casualty assessment model based on the following formula:
$$D = {α}_{m} \cdot {f}_{den} \cdot {f}_{t} \cdot {D}_{m} = {α}_{m} \cdot {f}_{den} \cdot {f}_{t} \cdot {e}^{12.2 {e}^{- {( ln ( I ) - 2.445 )}^{2} / {0.3}^{2}}} ,$$
wherein D represents an assessed earthquake death toll; αₘ represents an earthquake magnitude correction factor; fₜ represents an earthquake origin time correction factor; f_{den} represents a population density correction factor; Dₘ represents an average earthquake death toll obtained through fitting based on the epicentral intensity; and I represents the epicentral intensity.

3. The method for earthquake disaster level assessment according to claim 2, wherein the determining an earthquake economic loss assessment model based on the earthquake magnitude, the seismic intensity, and the GDP per capita specifically comprises:
determining the earthquake economic loss assessment model based on the following formula:
$$L = {γα}_{m} {L}_{m} = γ \cdot \frac{m + 0.669}{0.533 I + 2.669} \cdot {10}^{0.5996 m + 0.4011} ,$$
wherein L represents an assessed earthquake economic loss; Lₘ represents an earthquake economic loss obtained through fitting based on the earthquake magnitude; m represents the earthquake magnitude; and γ represents a correction factor for an economic development level in the seismic area.

4. The method for earthquake disaster level assessment according to claim 3, wherein the establishing an earthquake disaster level assessment model based on the casualty assessment model and the earthquake economic loss assessment model specifically comprises:
establishing the earthquake disaster level assessment model based on the following formula: σ=L+[a(f(R)−L)+b(f(G)−L)], wherein σ represents the earthquake disaster level; a represents a weighting factor of a relative value of a casualty toll to the earthquake disaster level, b represents a weighting factor of a relative value of the economic loss to the earthquake disaster level, and a+b=1; f(R) represents an earthquake disaster level corresponding to the casualty toll; and f(G) represents an earthquake disaster level corresponding to the relative value of the economic loss.

5. A system for earthquake disaster level assessment, comprising:
an earthquake disaster information obtaining module, configured to obtain earthquake disaster information at an initial stage of an earthquake, wherein the earthquake disaster information comprises an earthquake magnitude, an epicentral intensity, a seismic intensity, earthquake origin time, GDP per capita in an epicentral area, and a population density in a seismic area:
a casualty assessment model determining module, configured to determine a casualty assessment model based on the epicentral intensity as a core factor, the earthquake magnitude, the seismic intensity, the earthquake origin time, and the population density in the seismic area;
an earthquake economic loss assessment model determining module, configured to determine an earthquake economic loss assessment model based on the earthquake magnitude, the seismic intensity, and the GDP per capita;
an earthquake disaster level assessment model establishing module, configured to establish an earthquake disaster level assessment model based on the casualty assessment model and the earthquake economic loss assessment model; and
an earthquake disaster level determining module, configured to determine an earthquake disaster level based on the earthquake disaster level assessment model and initiate an emergency response based on the earthquake disaster level.

6. The system for earthquake disaster level assessment according to claim 5, wherein the casualty assessment model determining module specifically comprises:
a casualty assessment model determining unit, configured to determine the casualty assessment model based on the following formula:
$$D = {α}_{m} \cdot {f}_{den} \cdot {f}_{t} \cdot {D}_{m} = {α}_{m} \cdot {f}_{den} \cdot {f}_{t} \cdot {e}^{12.2 {e}^{- {( ln ( I ) - 2.445 )}^{2} / {0.3}^{2}}} ,$$
wherein D represents an assessed earthquake death toll; αₘ represents an earthquake magnitude correction factor; -fₜ represents an earthquake origin time correction factor; f_{den} represents a population density correction factor; Dₘ represents an average earthquake death toll obtained through fitting based on the epicentral intensity; and I represents the epicentral intensity.

7. The system for earthquake disaster level assessment according to claim 6, wherein the earthquake economic loss assessment model determining module specifically comprises:
an earthquake economic loss assessment model determining unit, configured to determine the earthquake economic loss assessment model based on the following formula:
$$L = {γα}_{m} {L}_{m} = γ \cdot \frac{m + 0.669}{0.533 I + 2.669} \cdot {10}^{0.599 \; 6 m + 0.4011} ,$$
wherein L represents an assessed earthquake economic loss; Lₘ represents an earthquake economic loss obtained through tilting based on the earthquake magnitude; m represents the earthquake magnitude; and γ represents a correction factor for an economic development level in the seismic area.

8. The earthquake disaster level assessment system according to claim 7, wherein the earthquake disaster level assessment model establishing module specifically comprises:
an earthquake disaster level assessment model establishing unit, configured to establish the earthquake disaster level assessment model based on the following formula: σ=L+[a(f(R)−L)+b(f(G)−L)], wherein σ represents the earthquake disaster level; a represents a weighting factor of a relative value of a casualty toll to the earthquake disaster level, b represents a weighting factor of a relative value of the economic loss to the earthquake disaster level, and a+b=1; f(R) represents an earthquake disaster level corresponding to the casualty toll; and f (G) represents an earthquake disaster level corresponding to the relative value of the economic loss.
